(19) United States
(12) Patent Application Publication
(10) Pub. No.: US 2018/0154870 A1
(43) Pub. Date: Jun. 7, 2018

(54) DRIVING ASSISTANCE DEVICE

(71) Applicant: SUZUKI MOTOR CORPORATION, Hamamatsu-shi (JP)

(72) Inventor: Koji KURATA, Hamamatsu-shi (JP)

(73) Assignee: SUZUKI MOTOR CORPORATION, Hamamatsu-shi (JP)

(21) Appl. No.: 15/825,788

(22) Filed: Nov. 29, 2017

(30) Foreign Application Priority Data
Dec. 2, 2016 (JP) 2016-235281

(51) Int. Cl. B60T 7/12; B60Q 9/00; G06K 9/00

(52) U.S. Cl. CPC B60T 7/12; G08G 1/095; G06K 9/00825; B60Q 9/00

(57) ABSTRACT

There is provided a driving assistance device. A driving assistance unit is configured to output an alarm for a driver of a vehicle, if an object recognizing unit recognizes that there are two or more traffic lights in front of the vehicle, and a signal displayed by a traffic light of the two or more traffic lights closest to the vehicle indicates prohibition against going straight, and a signal displayed by at least one farther traffic light father than the closest traffic light as seen from the vehicle indicates permission to progress or permission to progress in a limited direction, and a speed of the vehicle detected by a vehicle speed detecting unit exceeds an upper limit for such speed that it is possible to safely stop the vehicle at a position where the vehicle should stop according to the signal displayed by the closest traffic light.

### CROSS-REFERENCE TO RELATED APPLICATIONS

The disclosure of Japanese Patent Application No. 2016-235281 filed on Dec. 2, 2016, including specification, drawings and claims is incorporated herein by reference in its entirety.

### TECHNICAL FIELD

The present invention relates to a driving assistance device for assisting in driving a vehicle.

### BACKGROUND

The following Patent Document 1 discloses a safe driving assistance system for alerting a driver carelessly driving a vehicle, thereby preventing the vehicle from coming into an intersection against a signal. Specifically, in a case where it is necessary to stop the vehicle before an intersection on a red light, the safe driving assistance system adds a free running distance from when the driver recognizes that situation to when the driver starts decelerating the vehicle and a braking distance necessary to stop decelerating the vehicle, and specifies a position the total distance of the free running distance and the braking distance ahead of the intersection position as a recognition limit position. Then, in a case where the driver is carelessly driving the vehicle at the moment when the vehicle reaches the recognition limit position, the safe driving assistance system alters the driver by sound or light.

Patent Document 1: Japanese Patent Application Publication No. 2016-045681A

However, throughout each country, there are roads each of which extends straight and where there are two or more intersections, crosswalks, or the like in the extension direction of the corresponding road and there are traffic lights installed at the intersections, the crosswalks, or the like, respectively. In a case where a vehicle runs on such a road, signals displayed respectively by two or more traffic lights installed in a line in the extension direction of the road simultaneously come into the field of front vision of the driver of the vehicle.

In this case, the driver may fail to identify a signal displayed by a traffic light closest to the vehicle and a signal displayed by a traffic light farther than the closest traffic light as seen from the vehicle. For example, in a case where the signal displayed by the closest traffic light is red, and the signal displayed by the farther traffic light is blue, the drive may mistake the signal displayed by the farther traffic light for the signal displayed by the closest traffic light, and drives the vehicle into an intersection, a crosswalk, or the like where there is the closest traffic light, against the signal displayed by the closest traffic light.

Also, in the case where two or more traffic lights simultaneously come into the field of front vision of the driver as described above, and thus the driver falsely recognizes the signals, even if the safe driving assistance system disclosed in Patent Document 1 is used, it is difficult to prevent the driver from driving the vehicle into the intersection, the crosswalk, or the like where there is the closest traffic light, against the signal displayed by the closest traffic light.

In other words, the safe driving assistance system disclosed in Patent Document 1 alerts a driver carelessly driving a vehicle at the moment when the vehicle reaches a limit recognition position. The limit recognition position is a position the total distance of a free running distance and a braking distance ahead of an intersection where the vehicle should stop. Here, in general, the total distance of a free running distance and a braking distance is a stopping distance. Therefore, hereinafter, the total distance of a free running distance and a braking distance will be referred to as a stopping distance. It is considered that when a driver is just carelessly driving a vehicle, in general, the vehicle substantially maintains a constant speed. Therefore, if a stopping distance is calculated on the basis of the speed of the vehicle at that moment, and a position the stopping distance ahead of an intersection where the vehicle should stop is specified, and the driver is alerted at the specified position, it may be possible to prevent the vehicle from coming into the intersection.

However, in the case where two or more traffic lights simultaneously come into the field of the driver as described above, and thus the driver falsely recognizes the signals, there is a risk that the driver will accelerate the vehicle at a position close to the intersection, the crosswalk, or the like where there is the closest traffic light as will be described below. For example, even though the signal displayed by the closest traffic light is red, since the signal displayed by the farther traffic light is blue, if the driver falsely recognizes that the signal displayed by the closest traffic light is blue, the driver may think of crossing the intersection, the crosswalk, or the like where there is the closest traffic light before the signal is switched to yellow, and accelerate the vehicle toward the intersection, the crosswalk, or the like. In this case, even if a stopping distance is calculated on the basis of the speed of the vehicle after acceleration, and a position the stopping distance ahead of the intersection where the vehicle should stop is specified as an alerting position, the vehicle may be already passing that position. In this case, it is difficult to prevent the vehicle from coming into the intersection.

### SUMMARY

It is therefore an object of at least one aspect of the present invention to provide a driving assistance device capable of preventing a driver from driving a vehicle into an intersection, a crosswalk, or the like where there is a traffic light closest to the vehicle, against a signal displayed by the closest traffic light since the driver of the vehicle mistakes a signal displayed by a farther traffic light for the signal displayed by the closest traffic light.

According to an aspect of the embodiments of the present invention, there is provided a driving assistance device for assisting in driving a vehicle, including: an object recognizing unit configured to recognize objects in front of the vehicle; a vehicle speed detecting unit configured to detect a speed of the vehicle; and a driving assistance unit configured to output an alarm for a driver of the vehicle, if the object recognizing unit recognizes that there are two or more traffic lights in front of the vehicle, and a signal displayed by a traffic light of the two or more traffic lights closest to the vehicle indicates prohibition against going straight, and a signal displayed by at least one farther traffic light father than the closest traffic light as seen from the vehicle indicates permission to progress or permission to progress in a limited direction, and the speed of the vehicle detected by the vehicle speed detecting unit exceeds an upper limit for such speed that it is possible to safely stop the vehicle at a position where the vehicle should stop according to the signal displayed by the closest traffic light.

According to the above aspect, it is possible to prevent a driver from driving a vehicle into an intersection, a crosswalk, or the like where there is a traffic light closest to the vehicle, against a signal displayed by the closest traffic light, since the driver of the vehicle mistakes a signal displayed by a farther traffic light for the signal displayed by the closest traffic light.

### BRIEF DESCRIPTION OF THE DRAWINGS

In the accompanying drawings:

FIG. 1 is an explanatory view illustrating a road where there are two traffic lights and vehicles running on that road;

FIG. 2 is an explanatory view illustrating two traffic lights coming into the field of front vision of a driver of a vehicle of FIG. 1;

FIG. 3 is a block diagram illustrating the configuration of a driving assistance device according to an embodiment of the present invention;

FIG. 4 is an explanatory view illustrating images acquired by imaging two or more traffic lights existing in front of the vehicle;

FIG. 5 is a flow chart illustrating a process which the driving assistance device according to the embodiment of the present invention performs when the vehicle is running; and

FIG. 6 is a flow chart illustrating a process which the driving assistance device of the embodiment according to the present invention performs when the vehicle is stationary at a position where the vehicle should stop.

### DETAILED DESCRIPTION OF THE EMBODIMENTS

A driving assistance device of an embodiment according to the present invention is a driving assistance device for assisting in driving a vehicle, and includes an object recognizing unit, a vehicle speed detecting unit, and a driving assistance unit.

The object recognizing unit recognizes objects existing in front of the vehicle. The object recognizing unit can recognize that there are two or more traffic lights in front of the vehicle. Also, the object recognizing unit can identify a traffic light closest to the vehicle and a traffic light farther than the closest traffic light as seen from the vehicle, from two or more traffic lights existing in front of the vehicle. Also, the object recognizing unit can identify signals displayed by individual traffic lights.

In traffic lights, there are normal traffic lights and arrow type traffic lights. In signals which are displayed by normal traffic lights, there are permission to progress, stop, prohibition against progressing, and the like. For example, in Japan, permission to progress is signaled by turning on a blue (green) light, and stop is signaled by turning on a yellow light, and prohibition against progressing is signaled by turning on a red light. Also, in signals which are displayed by arrow type traffic lights, there are permission to go straight, permission to make a left turn, permission to make a right turn, stop, prohibition against progressing, and so on. For example, in Japan, permission to go straight, permission to make a left turn, and permission to make a right turn are signaled by combining turning on of a red light with turning on of blue (green) arrow lights indicating progression directions to be permitted. The object recognizing unit can recognize the colors, shapes, and so on of individual traffic lights, thereby capable of identifying signals displayed by the individual traffic lights.

The vehicle speed detecting unit detects the speed of the vehicle.

In a case where there are two or more traffic lights in front of the vehicle, and a signal displayed by the closest traffic light of two or more traffic lights indicates prohibition against going straight, and a signal displayed by at least one farther traffic light of the two or more traffic lights indicates permission to progress or permission to progress in a limited direction, and the speed of the vehicle detected by the vehicle speed detecting unit exceeds an upper limit for such speed that it is possible to safely stop the vehicle at a position where the vehicle should stop, the driving assistance unit outputs an alarm for the driver of the vehicle.

Prohibition against going straight is prohibition against progressing, permission to make a left turn, or permission to make a right turn. Also, permission to progress in a limited direction is permission to go straight, permission to make a left turn, or permission to make a right turn.

Also, the position where the vehicle should stop is a position where the vehicle should stop according to the signal displayed by the closest traffic light. For example, in a case where there is no other vehicle between the vehicle and the intersection, the crosswalk, or the like where there is the closest traffic light, the position where the vehicle should stop is right before a stop line of the intersection, the crosswalk, or the like where there is the closest traffic light (in a case where there is no stop line, right before the intersection, the crosswalk, or the like). Also, in a case where there is a stationary other vehicle in front of the stop line of the intersection, the crosswalk, or the like where there is the closest traffic light, the position where the vehicle should stop is a position which is behind the corresponding other vehicle and is at an appropriate distance from the corresponding other vehicle.

Also, when such speed that it is possible to safely stop the vehicle at the position where the vehicle should stop is referred to as the speed at which safe stopping is possible, an upper limit for such speed that safe stopping is possible is determined on the basis of the distance between the vehicle and the position where the vehicle should stop, and the like.

In a situation two or more traffic lights simultaneously come into the field of front vision of the driver of the vehicle, and a signal displayed by the closest traffic light of those traffic lights indicates prohibition against going straight, and a signal displayed by the farther traffic light indicates permission to progress or permission to progress in a limited direction, if the speed of the vehicle exceeds the upper limit for the speed at which safe stopping is possible, there is a possibility that the driver will mistake the signal displayed by the farther traffic light for the signal displayed by the closest traffic light. If the driver is left to falsely recognize the signals, there is a risk that the vehicle will come into the intersection, the crosswalk, or the like where there is the closest traffic light, against the signal displayed by the closest traffic light. According to the driving assistance device of the embodiment, in this case, it is possible to output an alarm for the driver. In this way, it is possible to make the driver realize the false recognition and decelerate the vehicle. Therefore, it is possible to prevent the vehicle from coming into the intersection, the crosswalk, or the like where there is the closest traffic light, against the signal displayed by the closest traffic light, and it is possible to improve the preventive safety capability of the vehicle.

Also, in the case where two or more traffic lights simultaneously come into the field of the driver, and thus the driver falsely recognizes the signals, as described above, there is a risk that the driver will accelerate the vehicle at a position close to the intersection, the crosswalk, or the like where there is the closest traffic light. Even in this case, if the vehicle is accelerated, whereby the speed of the vehicle exceeds the upper limit for the speed at which safe stopping is possible, the driving assistance device of the embodiment according to the present invention outputs an alarm such that the driver can stop accelerating the vehicle. Therefore, it is possible to prevent the vehicle from coming into the intersection, the crosswalk, or the like where there is the closest traffic light, against the signal displayed by the closest traffic light.

### EMBODIMENT

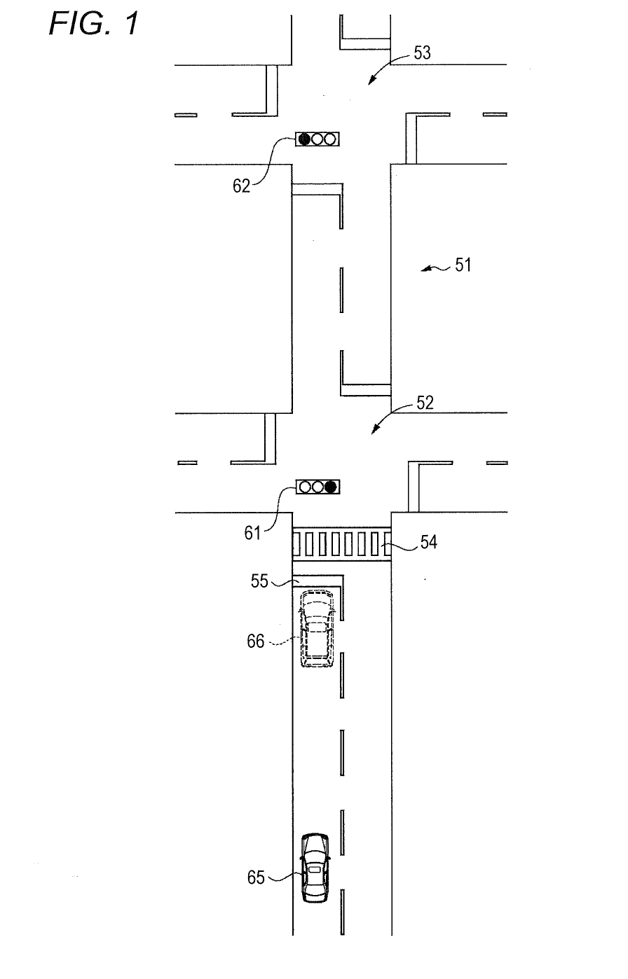

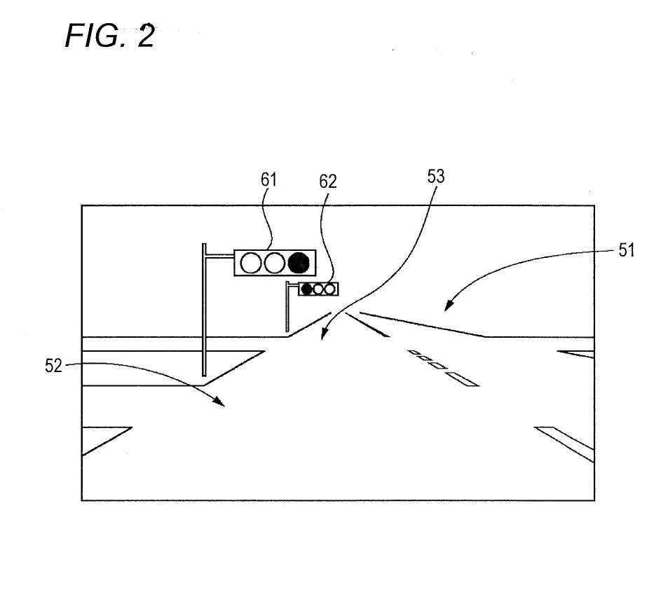

FIG. 1 shows a road 51 where there are two traffic lights 61 and 62, and vehicles such as a vehicle 65 running on the road. FIG. 2 shows the two traffic lights 61 and 62 and so on coming into the field of front vision of a driver of the vehicle 65 of FIG. 1. In FIG. 1, the road 51 extends straight, and on the road 51, there are, for example, two intersections 52 and 53 along the extension direction of the road 51. Also, at the intersection 52, there is a crosswalk 54. Further, the traffic lights 61 and 62 are at the intersections 52 and 53, respectively. The vehicle 65 is running on the road 51 from a position apart from the intersections 52 and 53 toward the intersections 52 and 53. At this time, the two traffic lights 61 and 62 installed respectively at the intersections 52 and 53 simultaneously come into the field of front vision of the driver of the vehicle 65, as shown in FIG. 2. In FIG. 2, the traffic light 61 is a traffic light closest to the vehicle 65, and the traffic light 62 is a traffic light farther than the closest traffic light as seen from the vehicle 65.

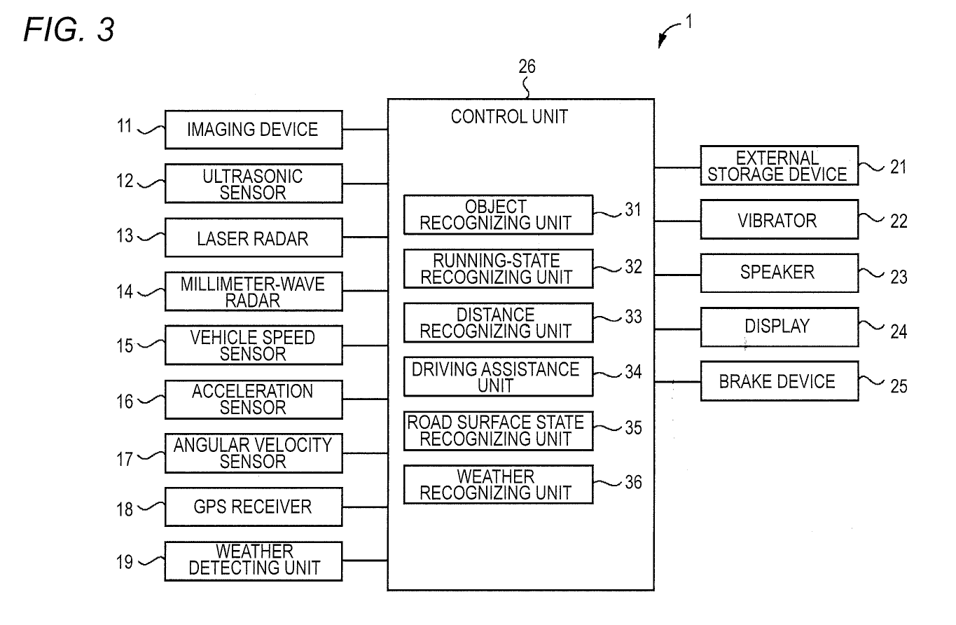

FIG. 3 shows the configuration of a driving assistance device 1 of the embodiment according to the present invention. The driving assistance device 1 of the embodiment according to the present invention is a device for assisting in driving the vehicle 65, and is installed on the vehicle 65. As shown in FIG. 3, the driving assistance device 1 is includes an imaging device 11, an ultrasonic sensor 12, a laser radar 13, and a millimeter-wave radar 14, as devices for detecting objects existing in front of the vehicle 65. The imaging device 11 is a device for imaging an area in front of the vehicle 65, thereby generating images, and is, for example, a digital camera. On the basis of the images generated by the imaging device 11, it is possible to detect the positions, shapes, colors, and so on of objects existing in front of the vehicle 65. Meanwhile, the ultrasonic sensor 12, the laser radar 13, and the millimeter-wave radar 14 are devices for detecting objects existing roughly in short-distance, middle-distance, and long-distance ranges, respectively. According to the ultrasonic sensor 12, the laser radar 13, and the millimeter-wave radar 14, it is possible to measure the distances between the vehicle and objects existing in front of the vehicle 65.

Also, the driving assistance device 1 includes a vehicle speed sensor 15, an acceleration sensor 16, and an angular velocity sensor 17, as devices for detecting the running state of the vehicle 65. The vehicle speed sensor 15, the acceleration sensor 16, and the angular velocity sensor 17 detect the speed, acceleration, and angular velocity of the vehicle 65, respectively.

Also, the driving assistance device 1 includes a GPS (global positioning system) receiver 18 as a device for detecting the position of the vehicle 65. The vehicle speed sensor 15, the acceleration sensor 16, and the angular velocity sensor 17 are also usable to detect the position of the vehicle 65. Also, the driving assistance device 1 has an external storage device 21, and the external storage device 21 retains map data. The map data is usable for detection of the position of the vehicle 65, recognition of the positions of the road 51, the intersections 52 and 53, the crosswalk 54, and the traffic lights 61 and 62, and so on.

Also, the driving assistance device 1 includes a weather detecting unit 19 for detecting weather. The weather detecting unit 19 includes, for example, a device for detecting raindrops.

Also, the driving assistance device 1 includes a vibrator 22, a speaker 23, and a display 24, as devices for alarming the driver. The vibrator 22 is a device for producing vibrations (a vibration producing device), and is installed, for example, on the handle of the vehicle 65, the driver's seat, or the like. The vibrator 22 alarms the driver by vibrations. Meanwhile, the speaker 23 alarms the driver by producing alarm sound. The display 24 alarms the driver by displaying an alarm message. Also, the driving assistance device may have an alarm lamp for alarming the driver by alarm light. Also, the driving assistance device 1 includes a brake device 25 for braking the vehicle 65. The brake device 25 is a device for automatically braking the vehicle 65 according to a command from a control unit 26.

Also, the driving assistance device 1 includes the control unit 26. The control unit 26 includes a CPU (a central processing unit) and an internal storage device. The control unit 26 may be implemented by adding a dedicated control unit for a driving assistance process to the vehicle 65, or may be implemented using an existing engine control unit for controlling running of the vehicle 65 and so on. The control unit 26 functions as an object recognizing unit 31, a running-state recognizing unit 32, a distance recognizing unit 33, a driving assistance unit 34, a road surface state recognizing unit 35, and a weather recognizing unit 36, for example, by reading programs stored in the internal storage device and executing the programs.

The object recognizing unit 31 recognizes objects existing in front of the vehicle 65, on the basis of the images generated by the imaging device 11, and a detection signal output from the ultrasonic sensor 12, the laser radar 13, or the millimeter-wave radar 14. Specifically, the object recognizing unit 31 recognizes whether there is any traffic light in front of the vehicle 65 or the number of traffic lights in front of the vehicle. Also, in a case where there are two or more traffic lights in front of the vehicle 65, the object recognizing unit 31 identifies a traffic light closest to the vehicle and a farther traffic light. Also, the object recognizing unit 31 recognizes signals displayed by individual traffic lights existing in front of the vehicle 65.

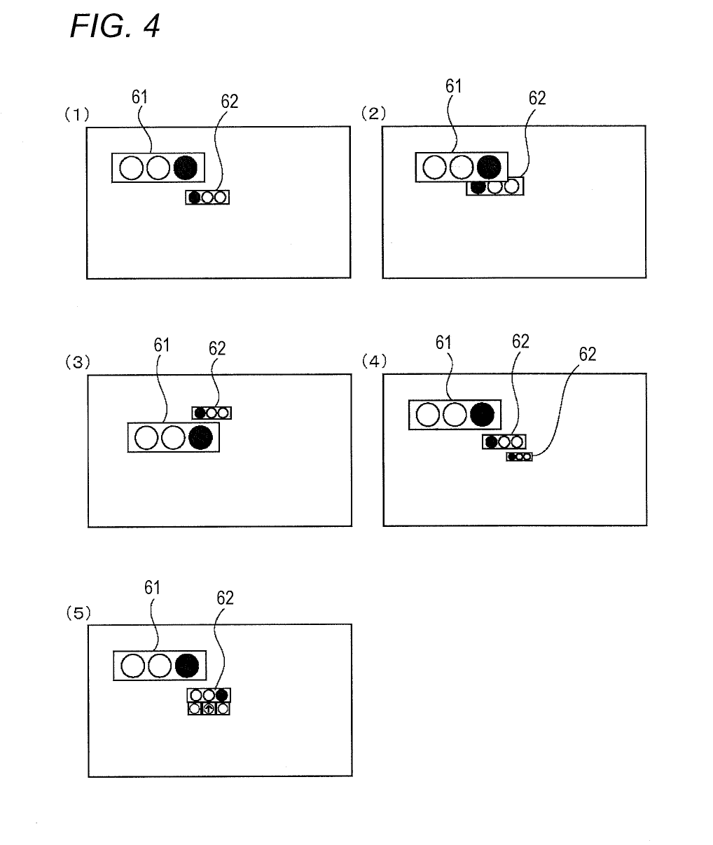

FIG. 4 shows images acquired by imaging areas in front of the vehicle 65 by the imaging device 11 during running of the vehicle 65 on roads existing in some different places. In each of images (1), (2), and (3) of FIG. 4, there are two traffic lights 61 and 62. In the image (1), the closest traffic light 61 is larger than a farther traffic light 62, and the closest traffic light 61 is higher than the farther traffic light 62. In the image (2), the closest traffic light 61 and the farther traffic light 62 partially overlap each other; however, similarly in the image (1), the closest traffic light 61 is larger than the farther traffic light 62, and the closest traffic light 61 is higher than the farther traffic light 62. Like this, the images are different in the sizes and positions of the closest traffic light 61 and the farther traffic light 62 included therein. The object recognizing unit 31 can identify the closest traffic light 61 and the farther traffic light 62 on the basis of the size relation between the individual traffic lights 61 and 62 included in the images and the positional relation between them. Meanwhile, in a case where the road is a slope and the closer side of the road is lower and the farther side of the road is higher, like in the image (3), the closest traffic light 61 may be lower than the farther traffic light 62. Even in this case, the object recognizing unit 31 can identify the closest traffic light 61 and the farther traffic light 62 by recognizing not only whether the road is a slope but also the size relation between the individual traffic lights and the positional relation between them. Also, an image (4) includes three traffic lights, and even in this case, the object recognizing unit 31 can identify the individual traffic lights by recognizing the size relation of the individual traffic lights and the positional relation of them. Also, in order to recognize the positional relation of individual traffic lights, traffic-light position information recoded in the map data may be used.

Also, an image (5) of FIG. 4 includes a traffic light 61 which is closest to the vehicle and is a normal traffic light, and a farther traffic light 62 which is an arrow type traffic light. In general, signals of a normal traffic light are indicated by lights having different ON/OFF states (an ON state, an OFF state, or a blinking state) and having different colors (red, or yellow, or blue (green)). Also, signals of an arrow type traffic light are indicated by lights having different ON/OFF states and having different shapes (arrow directions indicated by the lights). On the basis of the ON/OFF states, colors, and shapes of the individual traffic lights 61 and 62 included in each image, the object recognizing unit 31 can identify signals displayed by the individual traffic lights 61 and 62.

Meanwhile, the running-state recognizing unit 32 recognizes the running state of the vehicle 65. Specifically, the running-state recognizing unit 32 recognizes the speed of the vehicle 65, whether the vehicle 65 is stationary, and the like on the basis of a detection signal output from the vehicle speed sensor 15.

The distance recognizing unit 33 recognizes the distance between the vehicle 65 and a position where the vehicle should stop. The position where the vehicle should stop is a position where the vehicle should stop according to a signal displayed by the closest traffic light. For example, in a case where the vehicle 65 is running on the road 51 shown in FIG. 1 and there is no other vehicle 66 between the vehicle 65 and the intersection 52 where there is the closest traffic light 61, the position where the vehicle 65 should stop is right before a stop line 55 of the intersection 52 where there is the closest traffic light 61. Also, in a case where another vehicle 66 is stationary in front of the stop line 55, the position where the vehicle should stop is a position which is behind the other vehicle 66 and is at an appropriate distance from the other vehicle 66. On the occasion of recognizing the distance between the vehicle 65 and the position where the vehicle should stop, it is possible to recognize the position of the vehicle 65, for example, using information on the position of the vehicle 65 received by the GPS receiver 18, information on the position of the vehicle 65 calculated on the basis of detection signals from the vehicle speed sensor, the acceleration sensor 16, and the angular velocity sensor 17, and the map data stored in the external storage device 21. Also, it is possible to recognize the position of the stop line 55 using the position of the vehicle 65 recognized in the above-described way, the running direction of the vehicle 65 recognized on the basis of a detection signal from the acceleration sensor 16 or the angular velocity sensor 17, and the map data. Also, it is possible to recognize the position of the other vehicle 66 stationary in front of the stop line 55, using the imaging device 11, the laser radar 13, and the like.

The road surface state recognizing unit 35 recognizes the state of the road surface where the vehicle 65 runs. Specifically, the road surface state recognizing unit 35 recognizes whether the road surface of the road is wet with rain, whether the road surface is frozen, and the like on the basis of images generated by the imaging device 11 and so on.

The weather recognizing unit 36 recognizes the weather in the place where the vehicle 65 runs. Specifically, the weather recognizing unit 36 recognizes whether it is raining in the place where there is the vehicle 65, whether it is snowing, and the like on the basis of a detection signal output from the weather detecting unit 19 and the images generated by the imaging device 11.

The driving assistance unit 34 performs a driving assistance process of outputting an alarm for the driver of the vehicle 65 at the right time to assist the driver in driving the vehicle 65. In the driving assistance process, the driving assistance unit 34 determines whether to output an alarm, on the basis of whether there is any traffic light in front of the vehicle 65, and the positions of traffic lights in front of the vehicle recognized by the object recognizing unit 31, signals displayed by individual traffic lights recognized by the object recognizing unit 31, the speed of the vehicle 65 recognized by the running-state recognizing unit 32 (including recognition on whether the vehicle is stationary), the distance between the vehicle 65 and the position where the vehicle should stop recognized by the distance recognizing unit 33, the road surface state recognized by the road surface state recognizing unit 35, and the weather recognized by the weather recognizing unit 36. Also, in a case where it is necessary to output an alarm, the driving assistance unit 34 produces alarm sound from the speaker 23, or displays an alarm message on the display 24. Also, according to the driving assistance device 1 of the present embodiment, it is possible to alarm the driver by a plurality of methods such as outputting of alarm sound and displaying of an alarm message, and which method of the these methods will be used to give an alarm can be set, for example, by the driver.

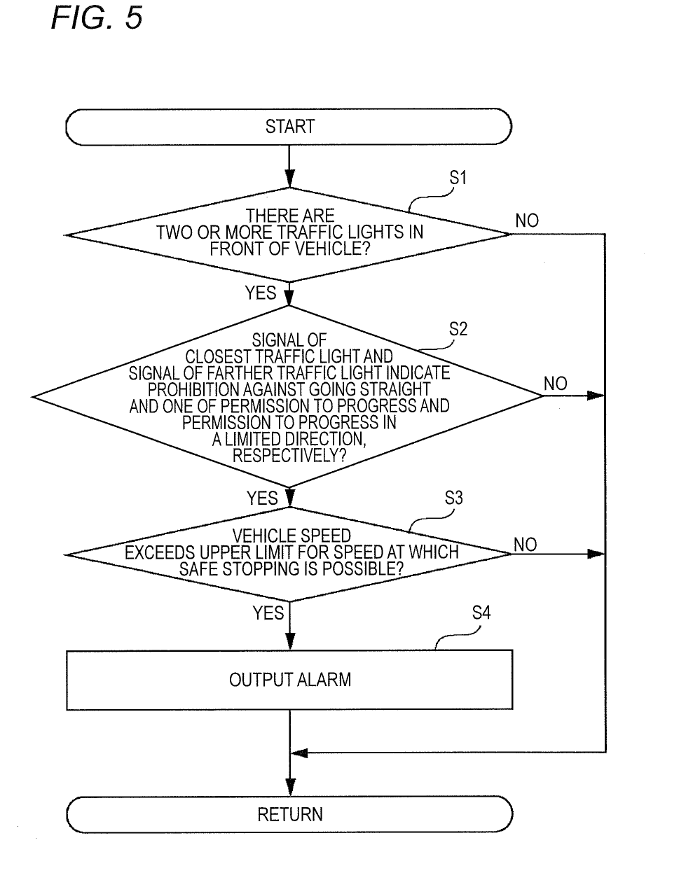

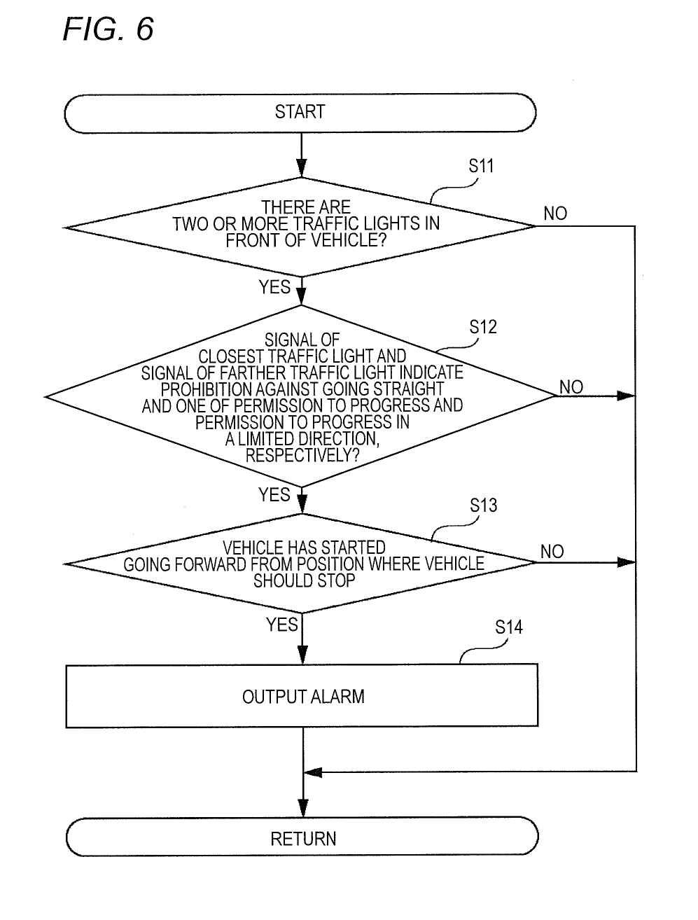

FIG. 5 and FIG. 6 show two driving assistance processes which are performed by the driving assistance unit 34. The driving assistance unit 34 determines whether the vehicle 65 is running or not, on the basis of a detection signal output from the vehicle speed sensor 15. Then, in a case where the vehicle 65 is running, the driving assistance unit 34 performs the driving assistance process shown in FIG. 5; whereas in a case where the vehicle 65 is stationary, the driving assistance unit performs the driving assistance process shown in FIG. 6.

First, the driving assistance process of FIG. 5 which is performed when the vehicle 65 is running will be described. In FIG. 5, first of all, the driving assistance unit 34 determines whether the object recognizing unit 31 has recognized that there were two or more traffic lights in front of the vehicle 65 (STEP S1).

In a case where the object recognizing unit 31 has recognized that there were two or more traffic lights in front of the vehicle 65 (“YES” in STEP S1), subsequently, the driving assistance unit 34 determines whether the object recognizing unit 31 has recognized that a signal displayed by a closest traffic light 61 indicated prohibition against going straight, and a signal displayed by a farther traffic light 62 indicated permission to progress or permission to progress in a limited direction (STEP S2).

Here, a signal indicating prohibition against going straight is a signal of a normal traffic light or an arrow type traffic light indicating prohibition against progressing (a state where a red light is on), a signal of an arrow type traffic light indicating permission to make a left turn (a state where a blue (green) light indicating the left direction is on), or a signal of an arrow type traffic light indicating permission to make a right turn (a state where a blue (green) light indicating the right direction is on). Also, a signal indicating permission to progress is a signal of a normal traffic light indicating permission to progress (a state where a blue (green) light is on). Also, a signal indicating permission to progress in a limited direction is a signal of an arrow type traffic light indicating permission to going straight (a state where a blue (green) light indicating the forward direction is on), a signal of an arrow type traffic light indicating permission to make a left turn, or a signal of an arrow type traffic light indicating permission to make a right turn.

In a case where the object recognizing unit 31 has recognized that the signal displayed by the closest traffic light 61 indicated prohibition against going straight, and the signal displayed by the farther traffic light 62 indicated permission to progress or permission to progress in a limited direction (“YES” in STEP S2), subsequently, the driving assistance unit 34 determines whether the speed of the vehicle 65 exceeds the upper limit for the speed at which safe stopping is possible (STEP S3). The speed at which safe stopping is possible is such speed that it is possible to safely stop the vehicle at a position where the vehicle should stop. In the present embodiment, an increment in vehicle movement distance attributable to false signal recognition is added to the distance between the vehicle and the position where the vehicle should stop, and when the distance obtained by the addition is referred to as the vehicle stopping distance, the upper limit for the speed at which safe stopping is possible is the speed of the vehicle corresponding to the stopping distance. Also, the speed at which safe stopping is possible will be described below in detail.

Specifically, in STEP S3, the driving assistance unit 34 recognizes the speed of the vehicle 65 on the basis of a detection signal output from the vehicle speed sensor 15. Also, the driving assistance unit 34 acquires the distance between the vehicle 65 and the position where the vehicle should stop, from the distance recognizing unit 33, and adds an increment in vehicle movement distance attributable to false signal recognition to the distance between the vehicle 65 and the position where the vehicle should stop. The distance obtained by the addition is referred to as the stopping distance of the vehicle 65. Then, the driving assistance unit 34 calculates the speed of the vehicle 65 corresponding to the stopping distance, i.e. the speed at which safe stopping is possible.

Further, the driving assistance unit 34 changes the upper limit for the speed at which safe stopping is possible, on the basis of the road surface state of the road recognized by the road surface state recognizing unit 35 and the weather recognized by the weather recognizing unit 36. Specifically, in a case where the road surface is wet by raining or snowing or in a case where the road surface is frozen, the driving assistance unit lowers the upper limit for the speed at which safe stopping is possible.

Then, the driving assistance unit 34 compares the speed at which safe stopping is possible calculated in the above-described way, with the actual speed of the vehicle 65 recognized on the basis of the detection signal output from the vehicle speed sensor 15, thereby determining whether the actual speed of the vehicle 65 exceeds the upper limit for the speed at which safe stopping is possible.

In a case where the speed of the vehicle 65 exceeds the upper limit for the speed at which safe stopping is possible (“YES” in STEP S3), the driving assistance unit 34 outputs an alarm (STEP S4). Specifically, as described above, the driving assistance unit 34 vibrates the vibrator 22, or produces alarm sound from the speaker 23, or display an alarm message on the display 24. The driving assistance device 1 keeps outputting the alarm, for example, until the speed of the vehicle becomes equal to or lower than the speed at which safe stopping is possible, or until the signal displayed by the closest traffic light 61 is switched to permission to going straight or permission to progress. If the speed of the vehicle becomes equal to or lower than the speed at which safe stopping is possible, or the signal displayed by the closest traffic light 61 is switched to permission to going straight or permission to progress, the driving assistance process finishes.

Meanwhile, in a case where the object recognizing unit 31 has not recognized that there were two or more traffic lights in front of the vehicle 65 (“NO” in STEP S1), or in a case where the object recognizing unit 31 has not recognized that the signal displayed by the closest traffic light 61 indicated prohibition against going straight, and the signal displayed by the farther traffic light 62 indicated permission to progress or permission to progress in a limited direction (“NO” in STEP S2), or in a case where the speed of the vehicle 65 does not exceed the speed at which safe stopping is possible (“NO” in STEP S3), the driving assistance unit 34 finishes the driving assistance process without outputting an alarm. The driving assistance process shown in FIG. 5 is repeatedly performed while the vehicle is running.

According to the driving assistance process shown in FIG. 5, even in a case where two traffic lights 61 and 62 simultaneously come into the field of front vision of the driver of the vehicle 65 running on the road 51 as shown in FIG. 2, whereby the driver falsely recognizes the signals, an alarm is output such that the driver can realize the false recognition and surely stop the vehicle 65 at the position where the vehicle should stop. Specifically, in a case where the vehicle 65 is running on the straight road 51 where there are two traffic lights 61 and 62 as shown in FIG. 1, as shown in FIG. 2, the closest traffic light 61 displaying a signal indicating prohibition against going straight and the farther traffic light 62 displaying a signal indicating prohibition against progressing or prohibition against progressing in a limited direction may simultaneously come into the field of front vision of the driver of the vehicle 65. In this situation, in a case where the speed of the vehicle 65 exceeds the speed at which safe stopping is possible, the driver may mistake the signal displayed by the farther traffic light 62 for the signal displayed by the closest traffic light 61, and falsely recognize that the signal displayed by the closest traffic light 61 indicates permission to progress or permission to progress in a limited direction. As a result, the driver may not recognize that it is necessary to stop the vehicle 65 at the position where the vehicle should stop. Therefore, if the driver is left to falsely recognize the signals, there is a risk that the vehicle 65 will come into the intersection 52 or the crosswalk 54 beyond the position where the vehicle should stop. According to the driving assistance process shown in FIG. 5, when the driver is in such a situation, an alarm is output such that the driver can realize false signal recognition and perform an operation to decelerate the vehicle 65. As a result, it is possible to safely stop the vehicle 65 at the position where the vehicle should stop or a position before the position where the vehicle should stop, and it is possible to prevent the vehicle 65 from coming into the intersection 52 or the crosswalk 54 against the signal displayed by the closest traffic light 61.

Now, the upper limit for the speed at which safe stopping is possible will be described. In a case where there is just an object in front of the vehicle, it is preferable that the upper limit for the speed at which safe stopping is possible be set to a value lower than an upper limit for the speed at which it is possible to safely stop the vehicle right before the corresponding object. Specifically, in a case where there is just an object in front of the vehicle, the upper limit for the speed at which it is possible to safely stop the vehicle right before the corresponding object is a speed corresponding to a stopping distance. This stopping distance means the distance between the vehicle and the position right before the object (the sum of a free running distance and a braking distance). In contrast, in a case of adding an increment in vehicle movement distance attributable to false signal recognition to the distance between the vehicle and the position where the vehicle should stop and referring to the distance obtained by the addition as the stopping distance, it is preferable that the upper limit for the speed at which safe stopping is possible be set to a speed corresponding to the stopping distance.

Further, it is preferable that the increment in vehicle movement distance attributable to the false signal recognition be, for example, a vehicle movement distance set in view of a delay in braking which is caused if the driver accelerates the vehicle due to false signal recognition. It is preferable to store increments in vehicle movement distance attributable to false signal recognition, for example, as a speed function determined in advance by experiments and the like or a data table representing the correspondence relation between a plurality of speed ranges and increments in vehicle movement distance attributable to false signal recognition, in the internal storage device of the control unit 26.

Increments in vehicle movement distance attributable to false signal recognition will be described more specifically. For example, in a case where the driver falsely recognizes that the signal displayed by the closest traffic light indicates permission to progress or permission to progress in a limited direction since the signal displayed by the farther traffic light indicates permission to progress or permission to progress in a limited direction even though the signal displayed by the closest traffic light indicates prohibition against progressing, the driver may think of crossing the intersection, the crosswalk, or the like where there is the closest traffic light before the signal displayed by the closest traffic light is switched to stop (a state where the yellow light is on) and accelerate the vehicle toward the intersection, the crosswalk, or the like. In the case where the vehicle accelerates, with the acceleration of the vehicle, the stopping distance of the vehicle lengthens. Meanwhile, in the driving assistance process, it takes a little time to recognize the speed of the vehicle, and recognize the distance between the vehicle and the position where the vehicle should stop, and calculate the speed at which safe stopping is possible, and output an alarm. Further, it takes a time for the driver to recognize the output alarm and it takes a time for the driver to realize the false signal recognition. Especially, since the driver falsely identifies the closest traffic light and the farther traffic light but does not falsely recognize the signals (the colors and the shapes), it may take a time to realize the false signal recognition. Therefore, at the moment when the driver realizes that it is necessary to brake the vehicle on the basis of output of an alarm, the actual distance between the vehicle and the position where the vehicle should stop is shorter than the distance between the vehicle and the position where the vehicle should stop used to calculate the distance necessary to safely stop the vehicle in the driving assistance process. Therefore, in a case where the distance between the vehicle and the position where the vehicle should stop is referred to simply as the stopping distance, and the upper limit for the speed at which safe stopping is possible is set to the speed corresponding to the stopping distance, the alarm outputting timing is delayed. Therefore, there is a risk that even if the driver decelerates the vehicle in response to the alarm, the vehicle will come into the intersection, the crosswalk, or the like beyond the position where the vehicle should stop.

In contrast, according to the driving assistance device 1 of the present embodiment, the speed function or the data table representing increments in vehicle movement distance attributable to false signal recognition is stored in the internal storage device of the control unit 26 in advance. The speed function or the data table is a function or a table generated by measuring the time taken to recognize the speed of the vehicle, and recognize the distance between the vehicle and the position where the vehicle should stop, and calculate the speed at which safe stopping is possible, and output the alarm in the driving assistance process, the time taken for the driver to recognize the output alarm, the time taken for the time to realize the false signal recognition, and the like by experiments and the like, and calculating the movement distance of the vehicle accelerating for the total time of the measured times, for example, with respect to each of a plurality of speed ranges determined during start of acceleration of the vehicle. Then, the increment in vehicle movement distance attributable to the false signal recognition is added to the distance between the vehicle and the position where the vehicle should stop, and the distance obtained by the addition is referred to as the stopping distance. When the driving assistance process is performed, a speed corresponding to the stopping distance is set as the upper limit for the speed at which safe stopping is possible. Since the upper limit for the speed at which safe stopping is possible is calculated by the above-described method, it is possible to advance the alarm outputting timing, and if the driver decelerates the vehicle in response to the alarm, it is possible to stop the vehicle 65 at the position where the vehicle should stop or in front of the position where the vehicle should stop, and it is possible to prevent the vehicle 65 from coming into the intersection 52 or the crosswalk 54.

Now, the driving assistance process of FIG. 6 which is performed when the vehicle 65 is stationary will be described. In FIG. 6, first of all, the driving assistance unit 34 determines whether the object recognizing unit 31 has recognized that there were two or more traffic lights in front of the vehicle 65 (STEP S11).

In a case where the object recognizing unit 31 has recognized that there were two or more traffic lights in front of the vehicle 65 (“YES” in STEP S11), subsequently, the driving assistance unit 34 determines whether the object recognizing unit 31 has recognized that a signal displayed by a traffic light 61 closest to the vehicle indicated prohibition against going straight, and a signal displayed by a farther traffic light 62 indicated permission to progress or permission to progress in a limited direction (STEP S12).

In a case where the object recognizing unit 31 has recognized that the signal displayed by the closest traffic light 61 indicated prohibition against going straight, and the signal displayed by the farther traffic light 62 indicated permission to progress or permission to progress in a limited direction (“YES” in STEP S12), subsequently, the driving assistance unit 34 determines whether the vehicle 65 has started going forward from the position where the vehicle should stop (STEP S13). Specifically, the driving assistance unit 34 recognizes that the vehicle 65 is at the position where the vehicle should stop, on the basis of information on the position of the vehicle 65 recognized by the GPS receiver 18 and the like. Also, the driving assistance unit 34 recognizes that the vehicle 65 has started going forward, on the basis of a detection signal output from the vehicle speed sensor 15.

In a case where the vehicle 65 has started going forward from the position where the vehicle should stop (“YES” in STEP S13), the driving assistance unit 34 outputs an alarm (STEP S14). The driving assistance device 1 keeps outputting the alarm, for example, until the vehicle 65 having started going forward stops, or until the signal displayed by the closest traffic light 61 is switched to permission to going straight or permission to progress. If the vehicle stops or the signal displayed by the closest traffic light 61 is switched to permission to going straight or permission to progress, the driving assistance process finishes.

Meanwhile, in a case where the object recognizing unit 31 has not recognized that there were two or more traffic lights in front of the vehicle 65 (“NO” in STEP S11), or in a case where the object recognizing unit 31 has not recognized that the signal displayed by the closest traffic light 61 indicated prohibition against going straight, and the signal displayed by the farther traffic light 62 indicated permission to progress or permission to progress in a limited direction (“NO” in STEP S12), or in a case where the vehicle 65 has not started going forward from the position where the vehicle should stop (“NO” in STEP S13), the driving assistance unit 34 finishes the driving assistance process without outputting an alarm. The driving assistance process shown in FIG. 6 is repeatedly performed while the vehicle is stationary in a state where the engine is operating.

According to the driving assistance process shown in FIG. 6, in a case where the vehicle 65 is stationary at the position where the vehicle should stop, and the closest traffic light 61 and the farther traffic light 62 simultaneously come into the field of front vision of the driver, whereby the driver falsely recognizes the signals, an alarm is output such that the driver can realize the false recognition. Therefore, it is possible to prevent the vehicle 65 from going forward from the position where the vehicle should stop and coming into the intersection 52 or the crosswalk 54. Specifically, when the vehicle is stationary at the position where the vehicle should stop, the closest traffic light 61 displaying the signal indicating prohibition against going straight and the farther traffic light 62 displaying the signal indicating prohibition against progressing or prohibition against progressing in a limited direction may simultaneously come into the field of front vision of the driver of the vehicle 65. In this situation, if the vehicle starts going forward, the driver may mistake the signal displayed by the farther traffic light 62 for the signal displayed by the closest traffic light 61, and falsely recognize that the signal displayed by the closest traffic light 61 indicates permission to progress or permission to progress in a limited direction. As a result, the driver may not recognize that it is necessary to stop the vehicle 65 at the position where the vehicle should stop. Therefore, if the driver is left to falsely recognize the signals, there is a risk that the vehicle 65 will come into the intersection 52 or the crosswalk 54. According to the driving assistance process shown in FIG. 6, when the driver is in such a situation, an alarm is output such that the driver can realize the false signal recognition and stop the vehicle 65 immediately after driving the vehicle 65 forward. Therefore, it is possible to prevent the vehicle 65 from coming into the intersection 52 or the crosswalk 54 against the signal displayed by the closest traffic light.

As described above, according to the driving assistance device 1 of the present embodiment, it is possible to prevent the driver of the vehicle 65 from driving the vehicle 65 into the intersection 52 or the crosswalk 54 where there is the closest traffic light 61, against the signal displayed by the closest traffic light 61 since the driver mistakes the signal displayed by the farther traffic light 62 for the signal displayed by the closest traffic light 61.

Also, the driving assistance device 1 of the present embodiment changes the upper limit for the speed at which safe stopping is possible, on the basis of the road surface state recognized by the road surface state recognizing unit 35. In this way, in a case where it is considered that the braking distance of the vehicle 65 will be longer, for example, in a case where the road surface is wet with rain or is frozen, it is possible to lower the upper limit for the speed at which safe stopping is possible. Therefore, in a case where the driver keeps running of the vehicle 65 due to the above-mentioned false signal recognition, it is possible to output an alarm for the driver at an earlier timing than that in clean or cloudy weather. Therefore, even in a case where the road surface is wet with rain or is frozen, it is possible to prevent the vehicle from coming into the intersection, the crosswalk, or the like against the signal displayed by the closest traffic light.

Also, according to the driving assistance device 1 of the present embodiment, on the basis of the weather recognized by the weather recognizing unit 36, the upper limit for the speed at which safe stopping is possible is changed. In this way, in a case where it is considered that the braking distance of the vehicle will be longer since it is raining or snowing, it is possible to lower the upper limit for the speed at which safe stopping is possible. Therefore, in a case where the driver keeps running of the vehicle 65 due to the above-mentioned false signal recognition, it is possible to output an alarm for the driver at an earlier timing than that when it is not raining or snowing. Therefore, even in a case where it is raining or snowing, it is possible to prevent the vehicle from coming into the intersection, the crosswalk, or the like against the signal displayed by the closest traffic light.

Also, the driving assistance device 1 of the present embodiment has the configuration in which the vibrator 22 is vibrated to alarm the driver. Therefore, for example, even in a case where it is difficult for the driver to see the display 24 since the driver is driving the vehicle 65, or it is difficult for the driver to listen alarm sound from the speaker 23 due to ambient noise, it is possible to surely alarm the driver. This configuration can exert a beneficial effect in a case where the vehicle to which the driving assistance device 1 is applied is a saddle-ridden type vehicle without an enclosed internal space, a four-wheeled vehicle without a roof like a car with an open roof, or the like.

Also, in the above-described embodiment, during running of the vehicle 65, if the driver mistakes the signal displayed by the farther traffic light 62 for the signal displayed by the closest traffic light 61 and thus does not decelerate the vehicle 65 even though the vehicle 65 gets close to the position where the vehicle should stop, an alarm is output for the driver. However, instead of outputting of an alarm or in addition to outputting of an alarm, the control unit 26 may control the brake device 25 (see FIG. 3) such that the brake device automatically brakes the vehicle 65. In this way, it is possible to surely decelerate the vehicle 65. Therefore, it is possible to surely prevent the vehicle 65 from coming into the intersection, the crosswalk, or the like against the signal displayed by the closest traffic light. However, in a case where the vehicle 65 is a motorcycle, there is a risk that automatic braking of the vehicle 65 against expectation of the driver will cause running of the vehicle 65 to be unstable. Therefore, in the case where the vehicle 65 is a motorcycle, in order to use the configuration for performing automatic braking, it is necessary to take due account of safety of running of the vehicle 65 during automatic braking.

Also, in the above-described embodiment, one condition for outputting an alarm is that the signal displayed by the closest traffic light 61 of two or more traffic lights existing in front of the vehicle 65 should indicate prohibition against going straight. In this condition, prohibition against going straight may include stop (a state where the yellow light is on). Also, in the above-described embodiment, one condition for outputting an alarm is that the signal displayed by the farther traffic light 62 of two or more traffic lights existing in front of the vehicle 65 should indicate permission to progress or permission to progress in a limited direction. Instead of this condition, a condition that the signal displayed by the farther traffic light 62 should indicate permission to progress, permission to progress in a limited direction, or stop.

Also, in the above-described embodiment, in the case of adding the increment in vehicle movement distance attributable to false signal recognition to the distance between the vehicle and the position where the vehicle should stop and referring to the distance obtained by the addition as the stopping distance, the upper limit for the speed at which safe stopping is possible is set to a speed corresponding to the stopping distance. However, the present invention is not limited thereto. For example, in a case where there is just an object in front of the vehicle, the upper limit for the speed at which safe stopping is possible may be set to a lower value corresponding to a predetermined percentage of the upper limit for the speed at which it is possible to safely stop the vehicle right before the object.

Also, in the above-described embodiment, in the case of outputting sound or a message as an alarm, it may be specifically informed to the driver that there is a possibility that the driver is mistaking the signal displayed by the farther traffic light 62 for the signal displayed by the closest traffic light 61. For example, sound or a message “Aren't you mistaking the farther signal for the closest signal?” may be output.

Also, the present invention can be applied to various vehicles, such as saddle-ridden type vehicles like motorcycles and motor tricycles, and four-wheeled automobiles.

Also, the present invention can be appropriately modified without departing from the gist and idea of the invention which can be read from claims and the entire specification, and driving assistance devices according to those modifications are also included in the technical idea of the present invention.

What is claimed is:

1. A driving assistance device for assisting in driving a vehicle, comprising:
an object recognizing unit configured to recognize objects in front of the vehicle;
a vehicle speed detecting unit configured to detect a speed of the vehicle; and
a driving assistance unit configured to output an alarm for a driver of the vehicle, if the object recognizing unit recognizes that there are two or more traffic lights in front of the vehicle, and a signal displayed by a traffic light of the two or more traffic lights closest to the vehicle indicates prohibition against going straight, and a signal displayed by at least one farther traffic light father than the closest traffic light as seen from the vehicle indicates permission to progress or permission to progress in a limited direction, and the speed of the vehicle detected by the vehicle speed detecting unit exceeds an upper limit for such speed that it is possible to safely stop the vehicle at a position where the vehicle should stop according to the signal displayed by the closest traffic light.

2. The driving assistance device according to claim 1, wherein if the object recognizing unit recognizes that there are the two or more traffic lights in front of the vehicle, and the signal displayed by the closest traffic light of the two or more traffic lights indicates prohibition against going straight, and the signal displayed by the at least farther traffic light of the two or more traffic lights indicates permission to progress or permission to progress in a limited direction, and the vehicle speed detecting unit detects that the vehicle stationary at the position where the vehicle should stop starts doing forward, the driving assistance unit outputs an alarm for the driver.

3. The driving assistance device according to claim 1, wherein the driving assistance unit brakes the vehicle instead of or in addition to outputting of the alarm.

4. The driving assistance device according to claim 1, further comprising a road surface state recognizing unit configured to recognize a state of a road surface where the vehicle runs,
wherein, on the basis of the state of the road surface recognized by the road surface state recognizing unit, the driving assistance unit changes the upper limit for the speed at which it is possible to safely stop the vehicle at the position where the vehicle should stop.

5. The driving assistance device according to claim 1, further comprising a weather recognizing unit configured to recognize weather in a place where the vehicle runs,
wherein, on the basis of the weather recognized by the weather recognizing unit, the driving assistance unit changes the upper limit for the speed at which it is possible to safely stop the vehicle at the position where the vehicle should stop.

6. The driving assistance device according to claim 1, further comprising a vibration producing device configured to apply vibration to the driver,
wherein the driving assistance unit performs application of the vibration to the driver by the vibration producing device, as outputting of the alarm.
